(19) United States
(12) Patent Application Publication
(10) Pub. No.: US 2009/0152201 A1
(43) Pub. Date: Jun. 18, 2009

(54) STABILIZED SILICA COLLOIDAL CRYSTALS

(75) Inventors: Mary J. Wirth, Tucson, AZ (US); Douglas S. Malkin, Tucson, AZ (US); Michael A. Legg, Tucson, AZ (US); Eric E. Ross, Spokane, WA (US)

Correspondence Address: OBLON, SPIVAK, MCCLELLAND MAIER & NEUSTADT, P.C., 1940 DUKE STREET, ALEXANDRIA, VA, 22314, US

(73) Assignee: THE ARIZONA BD OF REG ON BEHALF OF THE UNIV OF AZ, Tucson, AZ (US)

(21) Appl. No.: 12/257,178

(22) Filed: Oct. 23, 2008

Related U.S. Application Data
(60) Provisional application No. 61/125,974, filed on Apr. 30, 2008.
(60) Provisional application No. 61/000,014, filed on Oct. 23, 2007.

(51) Int. Cl. B01J 20/30; B01D 15/08; B32B 17/00; B01J 13/00

(52) U.S. Cl. 210/656; 428/447; 210/198.2; 516/111

(57) ABSTRACT

The present invention relates to stabilized silica colloidal crystals. In particular, the present invention relates to silica colloidal crystals having improved mechanical strength and durability. The present invention also relates to methods of making stabilized silica colloidal crystals by direct bonding between nanoparticles or between a polymer and nanoparticles through a siloxane bond.

### CROSS-REFERENCE TO RELATED APPLICATIONS

This application claims priority to provisional U.S. Application No. 61/000,014, filed Oct. 23, 2007, and the priority of provisional U.S. Application No. 61/125,974, filed Apr. 30, 2008, the entire contents of which are incorporated by reference herein in their entireties.

### STATEMENT REGARDING FEDERALLY FUNDED PROJECT

The United States Government owns rights in the present invention pursuant to Grant No. R01 GM065980 awarded by the National Institutes of Health.

### BACKGROUND OF THE INVENTION

1. Field of the Invention

The present invention relates to stabilized silica colloidal crystals. In particular, the present invention relates to silica colloidal crystals having improved mechanical strength and durability. The present invention also relates to methods of making stabilized silica colloidal crystals by direct bonding between nanoparticles or between a polymer and nanoparticles through a siloxane bond.

2. Discussion of the Background

Silica colloids naturally deposit in a highly ordered way, and the resulting materials promise to have many uses in biological analysis. These include substrates for microarrays, including oligonucleotides (e.g., DNA, RNA, etc.) proteins and cells, substrates for immunoassays, coatings for microscope slides to probe biological cells, media for capture and preconcentration of proteins and oligonucleotides, and media for chemical separations, such as media for gel electrophoresis, microchip or capillary electrochomatography, and ultraperformance chromatography. However the materials are far too fragile for any practical use as deposited.

The present inventors previously described a method to stabilize silica colloid crystals by sintering with high temperature (WO 07/127,921 and US 2007/0254161). In sintering, the temperature is high enough to melt just the surface of silica, and the flow of silica binds the adjacent particles after the temperature is lowered. However, there remains a need for a method of producing stabilized silica colloidal crystals, as well as the resultant stabilized silica colloidal crystals, at moderate temperatures where chemical bonds among reagent groups bind the silica surface to adjacent particles without destroying fragile substrates, such as glass or polymers, and without destroying the colloidal crystal by restricting excessive thermal expansion in confined spaces, such as the insides of capillaries.

### SUMMARY OF THE INVENTION

To address the foregoing need, the present inventors have developed a method to process silica colloid materials or silica nanosphere materials chemically at moderate temperatures. Chemical bonds are formed between the particles comprising the crystal to hold it together more stably. By the same technology, the crystal can also be made to adhere to its support.

The advantage of forming chemical bonds, as in the present invention, instead of sintering the material is that the latter can be performed at lower temperature. This capability is especially enabling for use of silica colloidal crystals in capillaries.

It is an object of the present invention to provide:

[1] A method of producing a stabilized silica colloidal crystal comprising cross-linking nanoparticles with a silane reactive group on the surface thereof by reacting said nanoparticles with a silane selected from the group consisting of a di-functional silane and a tri-functional silane.

[2] The method of [1], wherein said silane is a di-functional silane having the formula RR′SiX₂, wherein X is independently selected from the group consisting of Cl, methoxy and ethoxy, and R and R′ are independently selected from the group consisting of an alkyl group, a methacrylate, a vinyl groups, cyano, glycidoxy, an amino group, and an aldehyde group.

[3] The method of [1], wherein said silane is a tri-functional silane having the formula RSiX₃, wherein X is independently selected from the group consisting of Cl, methoxy and ethoxy, and R is selected from the group consisting of an alkyl group, a methacrylate, a vinyl groups, cyano, glycidoxy, an amino group, and an aldehyde group.

[4] The method of [1], wherein said stabilized silica colloidal crystal is simultaneously stabilized while bonding to a substrate, such as a glass or silica slide or the interior of a silica capillary. In a preferred embodiment, the substrate is composed of silica, glass, polydimethylsiloxane, or other material bearing silanol groups.

[5] The method of [4], wherein the substrate is bonded to the colloids through the R groups.

[6] A stabilized silica colloidal crystal prepared by the process of [1].

[7] A coated substrate, wherein said substrate is coated with a stabilized silica colloidal crystal of [6].

[8] The coated substrate of [7], wherein said coated substrate is a substrate for a protein, carbohydrate, oligonucleotide or cell microarray.

[9] The substrate of [7], wherein said substrate is a substrate making up the bottom surface of a multiwell plate.

[10] A method of separating materials in a composition comprising packing a cylindrical column with the stabilized colloidal crystal of [1] or a substrate that has been coated with the stabilized colloidal crystal, passing a composition containing a mixture of chemical species through the column, and recovering the fractions obtained thereby for further processing and/or analysis.

[11] A method of producing a stabilized silica colloidal crystal comprising cross-linking nanoparticles with a silane bearing a reactive group for the initiation of polymerization to cross-link said nanoparticles.

[12] The method of [11], wherein said silane is a mono-functional silane having the formula R(R′)₂SiX, wherein X is selected from the group consisting of hydrogen, Cl, methoxy and ethoxy, or any other silanol reactive group, R is a atom-transfer radical polymerization initiator, an acrylate, or a styrene, and R′ is independently selected from the group consisting of an alkyl group, a methacrylate, a vinyl groups, cyano, glycidoxy, an amino group, and an aldehyde group.

[13] The method of [11], wherein said silane is a di-functional silane having the formula RR′SiX₂, wherein X is independently selected from the group consisting of hydrogen, Cl, methoxy and ethoxy, or any other silanol reactive group, R is a atom-transfer radical polymerization initiator, an acrylate, or a styrene, and R′ is selected from the group consisting of an alkyl group, a methacrylate, a vinyl groups, cyano, glycidoxy, an amino group, and an aldehyde group.

[14] The method of [11], wherein said silane is a tri-functional silane having the formula RSiX₃, wherein X is independently selected from the group consisting of hydrogen, Cl, methoxy and ethoxy, or any other silanol reactive group, and R is a atom-transfer radical polymerization initiator, an acrylate, or a styrene.

[15] The method of [1]), wherein said stabilized silica colloidal crystal is further bonded to a coverplate selected from the group consisting of a polydimethylsiloxane or an elastomer.

[16] The method of [15], wherein the coverplate is bonded to the colloids through the R groups.

[17] The method of [11], where the polymer is patterned with holes for access to the colloidal crystal.

[18] The method of [11], wherein two or more different types of R groups are used to connect adjacent nanoparticles.

[19] The method of [11], wherein bis-vinyl groups are added to enhance cross-linking to connect adjacent nanoparticles.

[20] A stabilized silica colloidal crystal prepared by the process of [11].

[21] A substrate coated with a stabilized silica colloidal crystal of [20].

[22] The substrate of [21], wherein said substrate is a substrate for a protein, carbohydrate, oligonucleotide or cell microarray.

[23] The substrate of [21], wherein said substrate is a substrate making up the bottom surface of a multiwell plate.

[24] A method of separating materials in a composition comprising packing a cylindrical column with the stabilized colloidal crystal of [11] or a substrate that has been coated with the stabilized colloidal crystal, passing a composition containing a mixture of chemical species through the column, and recovering the fractions obtained thereby for further processing and/or analysis.

[25] A method of capturing materials in a composition comprising packing a cylindrical column with the stabilized colloidal crystal of [11] or a substrate that has been coated with the stabilized colloidal crystal, passing a composition containing a mixture of chemical species through the column, and recovering the captured fraction obtained thereby for further processing and/or analysis.

The above objects highlight certain aspects of the invention. Additional objects, aspects and embodiments of the invention are found in the following detailed description of the invention.

### BRIEF DESCRIPTION OF THE FIGURES

A more complete appreciation of the invention and many of the attendant advantages thereof will be readily obtained as the same becomes better understood by reference to the following Figures in conjunction with the detailed description below.

FIG. 1A depicts nanoparticles connected by forming siloxane (Si—O—Si) bonds between reagent groups on adjacent nanoparticles.

FIG. 1B depicts nanoparticles are connected by reaction between functional-groups, R and R on two different nanoparticles. R and R need not be the same group.

FIG. 2A depicts the nanoparticles bonded to a substrate through siloxane bonds.

FIG. 2B depicts the nanoparticles bonded to a substrate through organic polymer chains made by surface-initiated atom radical polymerization.

FIG. 3 shows a photograph of a microtiter plate with a successful deposition of high quality colloidal crystalline layers into the wells of a 96-well plate. The angular-dependent diffraction and the six-fold symmetry of the crystal are clearly visible. This approach of depositing a colloidal crystal into the wells imparts more than a 100× higher surface area to increase the sensitivity of ELISA and microarrays analyses (see Example 1).

FIG. 4a shows a photograph of typical silica colloidal crystal packed into a silica capillary. The blue color indicates excellent crystalline packing. Upon stabilization, this capillary holds up to at least 13,000 psi for hours, which is higher than the pressure achievable by most commercial ultrahigh pressure chromatographs. This stabilization allows capillaries to be widely used for ultraperformance liquid chromatography without the use of a frit. The length of the packing we use is typically 2.0 cm. (see Example 2)

### DETAILED DESCRIPTION OF THE INVENTION

Unless specifically defined, all technical and scientific terms used herein have the same meaning as commonly understood by a skilled artisan in chemistry and materials sciences.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

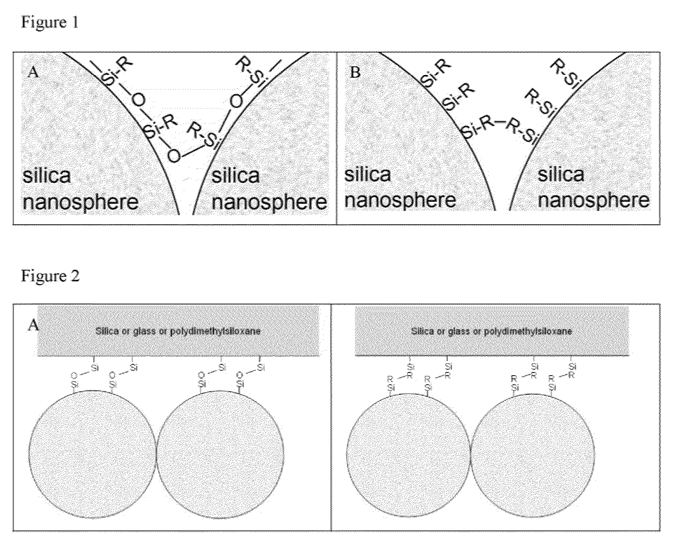

Within the context of the present invention, there are two ways to form covalent bonds across nanoparticles: 1) form siloxane (Si—O) bonds between reagents that are attached to two different particles, and 2) form covalent bonds between functional groups on silanes that are covalently attached to different nanoparticles. These different ways to form covalent bonds are illustrated in FIGS. 1 and 2.

In FIG. 1A, nanoparticles are connected by forming siloxane (Si—O—Si) bonds between reagent groups on adjacent nanoparticles. While in FIG. 1B, nanoparticles are connected by reaction between functional groups, R and R on two different nanoparticles. R and R need not be the same group.

In FIG. 2A, the nanoparticles are bonded to a substrate through siloxane bonds. And, in FIG. 2B, the nanoparticles are bonded to a substrate through organic groups joined by termination of atom-transfer radical polymerization.

For siloxane bond formation of FIG. 1A and FIG. 2a, we take advantage of the fact that di- or trifunctional silanes polymerize in the plane of the surface (U.S. Pat. Nos. 5,716,705, 5,599,625 and Wirth, M J; Fairbank, R W P; Fatunmbi, H O, “Mixed self-assembled monolayers in chemical separations” SCIENCE, 275 (5296): 44-47 (1997), and Fatunmbi, H O; Bruch, M D; Wirth, M J, “Si-29 and C-13 NMR characterization of mixed horizontally polymerized monolayers on silica-gel” ANALYTICAL CHEMISTRY, 65 (15): 2048-2054 (1993)), which we use herein to form bridges across particles. For this, we have demonstrated stabilization of the nanoparticles inside a silica capillary using any of a variety of silanes, all of which work well: 3-glycidoxypropyltrimethoxysilane, 3-aminopropyltrimethoxysilane, (chloromethyl)phenylethyltrichlorosilane, n-octadecyltriclilorosilatie, n-butyltrichlorosilane and methyltriclilorosilane. We have also demonstrated successful stabilization using binary mixtures of silanes, including methyltrichlorosilane with n-octadecyltrichlorosilane, methyltrichlorosilane with n-butyltrichlorosi lane, and methyltrichlorosilane with (chloromethyl)phenyl ethyl trichlorosilane. Stabilization was tested by applying at least 1000 psi of pressurized flow through the packed capillary using a syringe pump and determining whether the particles remained intact.

Another method of making chemical bonds between nanoparticles is to mix nanoparticles bearing one type of functional group with nanoparticles bearing a different type of functional group, choosing the two types to react with one another to form a covalent bond. After the film is deposited, these surface groups will react to form covalent bonds. Examples that are well known in the art are groups that would react with and bond to amino groups, including epoxide, aldehyde, cyanato, isothiocyanate, and succinimidyl ester groups. Other well known examples are groups that react with thiols, including maleimide, alkyl chloride or haloacetimide. The colloidal crystal can be made to adhere to its support, such as glass or fused silica, which can be a slide or a capillary, by treating the surface of the support with either type of functional group

For bonding through atom-transfer radical polymerization, as depicted in FIGS. 1B and 2B, we use the method of surface-initiated atom-transfer radical polymerization, where a silane covalently bonded to the silica surface bears an initiator for polymerization. This method was developed in our research group (Huang, X Y, Wirth, M J, “Surface-initiated radical polymerization on porous silica”, ANALYTICAL CHEMISTRY, 69 (22): 4577-4580 (1997), and Huang, X Y; Doneski, L J; Wirth, M J “Surface-confined living radical polymerization for coatings in capillary electrophoresis” ANALYTICAL CHEMISTRY, 70 (19): 40234029 (1998)) We have previously showed that the polymerization proceeds with significant termination (Huang, X; Wirth, M J, “Surface initiation of living radical polymerization for growth of tethered chains of low polydispersity” MACROMOLECULES, 32 (5): 1694-1696 (1999)), and the gradual disappearance of the chloro group indicates that many of these termination events are caused by living ends of chains binding together. When this termination of chain ends occurs on polymer chains bound to adjacent nanoparticles, it binds the particles together. We have demonstrated that atom-transfer radical polymerization indeed stabilizes the silica colloidal crystal. For this demonstration, we used a monochlorosilane bearing a benzyl chloride group as the initiator and acrylamide as the monomer, and we found that the resulting material remained stably inside of the capillary.

Accordingly, in an embodiment of the present invention is provided a reaction of silica colloidal crystal with di- or trifunctional silane to cross-link the silica colloidal crystal particles by forming siloxane bonds to connect adjacent nanoparticles. The silane used in the present invention forms bonds between the silicon atoms of the reagent silicon atoms as they are covalently attached to the surface. The silane suitable for use in the present invention may have the formulae: RR′SiX₂ or RSiX₃. In the silane of the present invention, X is hydrogen, a halogen, preferably Cl, or a lower alkoxy, preferably methoxy or ethoxy, or any other silanol reactive group. R and R′ in the silane of the present invention can be any desired functional group. Preferred examples include alkyl groups, preferably a C₁ to C₆-alkyl, for example methyl, methacrylate or other vinyl groups, cyano, glycidoxy, amino or aldehyde groups.

The conditions (e.g., temperature, concentrations, etc.) would be appreciated by those practiced in the art. The preferred method of the present invention is to use any of the silanes because these silanes accomplish bonding in just one step. There is no preference among the silanes as the silane selected would depend on the desire of the customer.

In the context of the present invention, the silica colloidal crystals may be reacted with a mono-, di- or trifunctional silane.

In this embodiment, the silane is represented by the formulae: R(R′)₂SiX, R(R′)SiX₂, or RSiX₃. In these silanes, X is a hydrogen halogen, preferably Cl, or a lower alkoxy, preferably methoxy or ethoxy, or any other silanol reactive group. R′ in this silane can be any desired functional group. Preferred examples include alkyl groups, preferably a C₁ to C₆-alkyl, for example methyl, methacrylate or other vinyl or allyl groups, cyano, glycidoxy, amino or aldehyde groups. R in the silane of this embodiment a reactive group from which a polymer can grow. Examples of the R group include atom-transfer radical polymerization initiators and vinyl groups, such as the acrylate family or the styrenes, which form covalent bonds between R groups to connect adjacent nanoparticles.

In the present invention, where there are two or more R, R′, or X groups, the R, R′, and X need not be the same. In other words, each R, R′, and X is independently selected from each other.

In another embodiment of the present invention, a bis-vinyl group, such as bisacrylamide, may be added to enhance cross-linking to connect adjacent nanoparticles.

In still another embodiment of the present invention, covalent bonds may be formed in the absence of polymerizable groups. Examples including mixtures of amino and glycidoxy groups, or mixtures of isocyanto and glycidoxy groups, to connect adjacent nanoparticles.

It is also embraced by the present invention that the aforementioned reactions and the products obtained thereby can be further used for bonding a substrate, including a slide or the walls comprising the interior of a capillary, to the nanoparticles, or the material can be sandwiched between two substrates. The substrate within the context of the present invention can be glass, silica, or polydimethylsiloxane, since each of these bears a silanols group that would react with the silane to form siloxane bonds, as depicted in FIG. 2A, or the material can be any substrate made to bear an initiator to atom-transfer radical polymerization, which includes polymers, metals, and oxides, to form covalent bonds as depicted in FIG. 2B. Thus, any substrate bearing a silanol group (—SiOH), a —SiX group (where X is a hydrogen, Cl, methyoxy, or ethoxy), a vinyl group, or an initiator to atom-transfer radical polymerization may be used in the present invention. For example, the substrate may be a polymer sheet or polymer tube bearing any one of these silane reactive groups. In another embodiment of the present invention is a stabilized colloidal crystal prepared by the aforementioned reactions.

The substrate upon which the stabilized colloidal crystal of the present invention can be coated can be electrically conductive, e.g., a metal or a semiconductor, or can be electrically insulating, e.g., an insulator, over at least a portion of the substrate. In embodiments, the substrate can be a glass, fused silica, crystallized silica (quartz), sapphire, silicon, indium tin oxide or platinum. The substrate can have a flat, curved, irregular, or patterned surface, on which the stabilized colloidal crystal is deposited. The surface on which the stabilized colloidal crystal is deposited can be an outer surface of the substrate. The surface on which the stabilized colloidal crystal is deposited can also be an inner surface of a substrate, for example the inner surface of a capillary tube or the inner surface of a hole. The cross-section of the inner surface can be circular, oval, elliptical or polygonal (e.g., triangular or square). The surface of the substrate can include regions having different compositions. The substrate serves as a mold for the stabilized colloidal crystal. For example, a flat substrate can produce a colloidal crystal shaped as a flat film, and a capillary tube can produce a colloidal crystal shaped as a cylinder. For capillaries, we have used inner diameters ranging from 20 μm to 4 mm, and silica particle sizes ranging from 200 nm to 1.5 μm, and we encountered no problems, indicating that these extremes are not the limits. For slides, one would reasonably expect that the same thickness ranges and particle sizes to apply, and the chemistry is not subject to particle size or thickness limitations. We have demonstrated stability for colloidal crystal s on slides using colloidal crystals of 10 μm in thickness. The stabilized colloidal crystals on slides can be touched with a latex-gloved hand without damage, in contrast to untreated colloidal crystals on slides. The stabilized colloidal crystals on slides also withstand routine steps used for chemical modification, including boiling in water or other solvents, in contrast to untreated colloidal crystals on slides.

Identification of unknown chemical species relies upon methods of separation to isolate material to be identified. Separation media have been indispensable in molecular biology for separation biological macromolecules such as proteins and nucleic acids, as well as for determining sequences of polypeptides and nucleic acids. The stabilized colloidal crystal of the present invention can be used as a separation media.

For example, the stabilized colloidal crystal of the present invention can be used as a separation media in processes which include passing a fluid (liquid or gas) through the sintered silica crystal. Such processes include chromatography processes, for example High Performance Liquid Chromatography (HPLC) and Thin Layer Chromatography (TLC).

The stabilized colloidal crystal of the present invention can also be used in processes which include passing a fluid through the stabilized colloidal crystal of die present invention and applying an electric potential across the stabilized colloidal crystal of the present invention. Such processes include separation processes such as electrophoresis, electrophoretic sieving, isoelectric focusing and electrochromatography. Such processes are applicable to any charged chemical species, e.g., peptides, proteins, oligonucleotides such as RNA, DNA, and, pharmaceuticals and ionic species that are environmentally important. The electric potential can be applied via electrodes arranged on opposite ends of the stabilized colloidal crystal of the present invention.

The stabilized colloidal crystal of the present invention can be used to provide increased surface area for reactions or capture (particularly in microarrays for proteomics or genomics). In other words, the stabilized colloidal crystal of the present invention can be used in processes in which a first chemical species is bound to the colloidal silica particles, a fluid passing through the stabilized colloidal crystal of the present invention contains a second chemical species, and the second species is captured on the first chemical species. For example, oligonucleotides can be used to capture other oligonucleotides, antibodies can be used to capture antigens or vice versa, lectins can be used to capture glycoproteins or vice versa, and antibodies can be used to capture various chemical species and vice versa. The stabilized colloidal crystal of the present invention can be used as a substrate for microarrays that use chemically bound capture proteins to capture, e.g., antigens. The stabilized colloidal crystal of the present invention can be functionalized with other chemical species, such as silylating agents, polyacrylamide, other polymers, DNA, antibodies, and proteins.

Thus, the stabilized colloidal crystal of the present invention are used in printed DNA microarrays, printed protein microarrays, or printed carbohydrate microarrays.

The stabilized colloidal crystal of the present invention can be used in processes in which living cells are grown on the stabilized colloidal crystal of the present invention. The porosity of the stabilized colloidal crystal of the present invention allows chemical species, such as water, nutrients and drugs, to reach the cell surfaces. The stabilized colloidal crystal of the present invention can also be used in processes in which a lipid bilayer or cell membrane is attached to the stabilized colloidal crystal of the present invention.

The stabilized colloidal crystal of the present invention can also be used as microporous coatings on microscope slides and coverslips. Cells grown on such microporous coatings can be interrogated by microscopic techniques, such as Total Internal Reflection Fluorescence Microscopy (TIRFM), in which light is passed through the stabilized colloidal crystal of the present invention.

The stabilized colloidal crystal of the present invention can be used in processes in which an organic material is introduced into the stabilized colloidal crystal of the present invention and the organic material is then vaporized and ionized. Such processes include Matrix-assisted laser desorption/ionization (MALDI) mass spectrometry.

The stabilized colloidal crystal of the present invention can be used to coat and/or deposit on glass, plastic or polymer bottoms of multiwell plates, such as microwell or microtiter plates, or to fill tubes or capillaries.

The present invention provides a method for separation of materials by packing a cylindrical column with the stabilized colloidal crystal of the present invention or a substrate that has been coated with the stabilized-colloidal crystal of the present invention, then passing a composition containing a mixture of chemical species through the column, and recovering the fractions obtained thereby for further processing and/or analysis. In this method, the cylindrical column may be used in chromatography, solid phase extraction, or electrophoresis.

The capillaries or tubes packed with stabilized silica colloidal crystals also have use for capturing and pre-concentrating analytes, such as proteins, oligonucleotides, and carbohydrates. By suitable choice of an R group as in FIGS. 1A and 1B, a protein or an oligonucleotide can be captured, in an analogous manner to the capture process used for a microarray. We have demonstrated that, choosing R of FIG. 1 to be an epoxide group, that an antibody (anti-bovine serum albumin) is covalently bound to the silica colloidal crystals, and further, that this antibody captures bovine serum albumin that is labeled with a fluorophor (Alexa Fluor 647). The capillary becomes fluorescent when the fluorescein-labeled bovine serum albumin is introduced. We used electrophoretic migration of the bovine serum albumin to introduce it into the capillary.

The method is applicable to any antibody and any protein, provided that the pores of the silica colloidal crystal are sufficiently large. This typically would require the nanoparticles to be at least 200 nm in diameter. It is also advantageous to collect messenger RNA to increase the sample concentration prior to analyses that use gene expression microarrays, or to increase sample concentration of other oligonucleotides. such as RNAi, or genes or gene fragments. This would be achieved by having a suitable complementary R-group of FIG. 1 on the silica surface, such as poly-A for messenger RNA, or a complementary sequence for RNAi, or a primer for binding a DNA oligonucleotide. The colloidal crystal can also be useful in pre-concentrating glycoproteins by choosing a suitable lectin as the R group of FIG. 1.

We previously demonstrated that live cells adhere to and can be grown on silica colloidal crystals (Velarde, T R C; Wirth, M J “Silica colloidal crystals as porous substrates for total internal reflection fluorescence microscopy of live cells” APPLIED SPECTROSCOPY, 62 (6): 611-616 (2008)). We disclose herein that a colloidal crystal stabilized by the methods depicted in FIG. 1 can therefore be useful for cell microarrays in place of the gelatins that are used today (Sturzl, M; Konrad, A; Sander, G; Wies, E; Neipel, F; Naschberger, E; Reipschlager, S; Gonin-Laurent, N; Horch, R E; Kneser, U; Hohenberger, W; Erfle, H; Thurau, M. High throughput screening of gene functions in mammalian cells using reversely transfected cell arrays: Review and protocol. COMBINATORIAL CHEMISTRY & HIGH THROUGHPUT SCREENING 11 (2): 159-172. (2008). For this application, the R group of FIG. 1 would be chosen to weakly bind the species to be introduced locally into the cells.

Thus, the stabilized silica colloid crystals of the present invention are useful in 1) oligonucleotides (such as DNA or RNA), protein, lectin, carbohydrate, peptide, aptamer, tissue, antibody or any other microarray or multiwell plate assays, 2) substrates for immunoassays, 3) electrophoresis media for proteomics or genomics, 4) high performance or ultra-performance liquid chromatography or molecular sieving, 5) material for capture and preconcentration of proteins or oligonucleotides, and 6) substrate for cell growth and cell microarrays.

The above written description of the invention provides a manner and process of making and using it such that any person skilled in this art is enabled to make and use the same, this enablement being provided in particular for the subject matter of the appended claims, which make up a part of the original description.

As used herein, the phrases “selected from the group consisting of,” “chosen from,” and the like include mixtures of the specified materials.

Where a numerical limit or range is stated herein, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Having generally described this invention, a further understanding can be obtained by reference to certain specific examples, which are provided herein for purposes of illustration only, and are not intended to be limiting unless otherwise specified.

### EXAMPLES

### Example 1

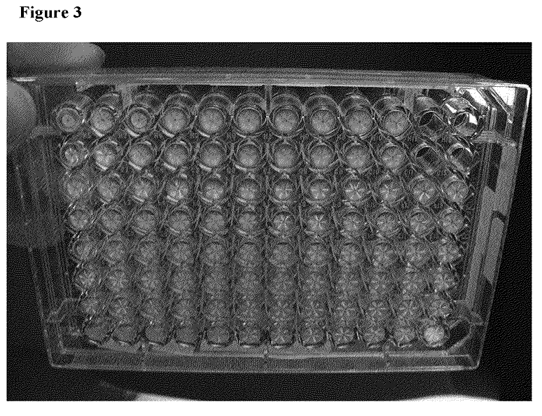

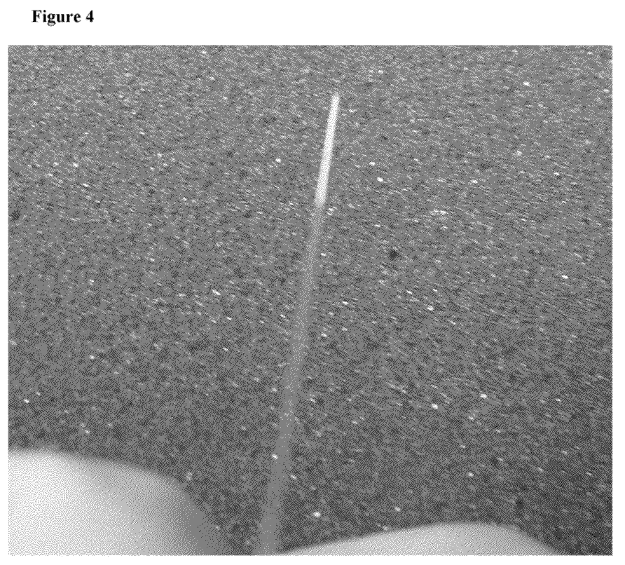

The example in FIG. 3 was made by depositing, into almost every well, 60 μL of a slurry of 300-nm diameter silica nanoparticles, which were made by the method of Stober (Stober, W; Fink, A; Bohn, E, “Controlled Growth of Monodisperse Silica Spheres in Micron Size Range” JOURNAL OF COLLOID AND INTERFACE SCIENCE, 26 (1); 62-69, 1968). The nanoparticles had a concentration of 5 mg/mL in water, and allowed to evaporate in an incubator at 40° C. To stabilize the colloidal crystal, a 5% solution of 3-aminopropyltrimethoxysilane in ethanol was pipetted into the wells, a lid was placed over the microplate, and the reaction was allowed to proceed at 40° C. for three hours, after which the wells were rinsed with ethanol.

### Example 2

A 10-cm capillary was immersed into a slurry of 30% by weight of 300-nm silica nanoparticles in water. The nanoparticles were made in the same Stober method as in Example 1. The vessel was put into a sonicator (VWR 75HT) to keep the particles dispersed. Once capillary forces have brought the slurry up into the entire length of the capillary, the capillary is removed from the slurry. The capillary was taken out of the slurry, and the excess water inside the capillary was removed by overnight at room temperature in a humidity chamber at 50% relative humidity. The loss of water shrunk the crystal to a 2 cm length and formed a high quality colloidal crystal, as evidenced by the blue color, which results from Bragg diffraction. Capillary forces were then used to draw in a solution of 5% n-butyltrichlorosilane in toluene into the colloidal crystal in the capillary, and the reaction was allowed to proceed for 3 hours. The capillary was then rinsed by drawing in dry toluene by capillary forces to remove excess reagent, then heated at 120° C. for two hours to form the siloxane bonds.

Numerous modifications and variations on the present invention are possible in light of the above teachings. It is, therefore, to be understood that within the scope of the accompanying claims, the invention may be practiced otherwise than as specifically described herein.

What we claim is:

1. A method of producing a stabilized silica colloidal crystal comprising cross-linking nanoparticles with a silane reactive group on the surface thereof by reacting said nanoparticles with a silane selected from the group consisting of a di-functional silane and a tri-functional silane.

2. The method of claim 1, wherein said silane is a di-functional silane having the formula RR′SiX₂, wherein
X is independently selected from the group consisting of Cl, methoxy and ethoxy, and
R and R′ are independently selected from the group consisting of an alkyl group, a methacrylate, a vinyl groups, cyano, glycidoxy, an amino group, and an aldehyde group.

3. The method of claim 1, wherein said silane is a tri-functional silane having the formula RSiX₃, wherein
X is independently selected from the group consisting of Cl, methoxy and ethoxy, and
R is selected from the group consisting of an alkyl group, a methacrylate, a vinyl groups, cyano, glycidoxy, an amino group, and an aldehyde group.

4. The method of claim 1, wherein said stabilized colloidal crystal is simultaneously stabilized while bonding to a substrate of silica, glass, polydimethylsiloxane, or other material bearing silanol groups.

5. The method of claim 4, wherein the substrate is bonded to the colloids through the R groups.

6. A stabilized silica colloidal crystal prepared by the process of claim 1.

7. A coated substrate, wherein said substrate is coated with a stabilized silica colloidal crystal of claim 6.

8. The coated substrate of claim 7, wherein said coated substrate is a substrate for a protein, carbohydrate, oligonucleotide or or cell microarray.

9. The coated substrate of claim 7, wherein said coated substrate is a substrate making up the bottom surface of a multiwell plate.

10. A method of separating materials in a composition comprising
packing a cylindrical column with the stabilized colloidal crystal of claim 1 or a substrate that has been coated with the stabilized colloidal crystal,
passing a composition containing a mixture of chemical species through the column, and
recovering the fractions obtained thereby for further processing and/or analysis.

11. A method of producing a stabilized silica colloidal crystal comprising cross-linking nanoparticles with a silane bearing a reactive for the initiation of polymerization to cross-link said nanoparticles.

12. The method of claim 11, wherein said silane is a mono-functional silane having the formula R(R′)₂SiX, wherein
X is selected from the group consisting of hydrogen, Cl, methoxy and ethoxy, or any other silanol reactive group,
R is a atom-transfer radical polymerization initiator, an acrylate, or a styrene, and
R′ is independently selected from the group consisting of an alkyl group, a methacrylate, a vinyl groups, cyano, glycidoxy, an amino group, and an aldehyde group.

13. The method of claim 11, wherein said silane is a di-functional silane having the formula RR′SiX₂, wherein
X is independently selected from the group consisting of hydrogen, Cl, methoxy and ethoxy, or any other silanol reactive group,
R is a atom-transfer radical polymerization initiator, an acrylate, or a styrene, and
R′ is selected from the group consisting of an alkyl group, a methacrylate, a vinyl groups, cyano, glycidoxy, an amino group, and an aldehyde group.

14. The method of claim 11, wherein said silane is a tri-functional silane having the formula RSiX₃, wherein
X is independently selected from the group consisting of hydrogen, Cl, methoxy and ethoxy, or any other silanol reactive group, and
R is a atom-transfer radical polymerization initiator, an acrylate, or a styrene.

15. The method of claim 11, wherein said stabilized silica colloidal crystal is further bonded to a coverplate selected from the group consisting of a polydimethylsiloxane or an elastomer.

16. The method of claim 15, wherein the coverplate is bonded to the colloids through the R groups.

17. The method of claim 11, where the polymer is patterned with holes for access to the colloidal crystal.

18. The method of claim 11, wherein two or more different types of R groups are used to connect adjacent nanoparticles.

19. The method of claim 11, wherein bis-vinyl groups are added to enhance cross-linking to connect adjacent nanoparticles.

20. A stabilized silica colloidal crystal prepared by the process of claim 11.

21. A substrate coated with a stabilized silica colloidal crystal of claim 20.

22. The substrate of claim 21, wherein said substrate is a substrate for a protein, carbohydrate, oligonucleotide or cell microarray.

23. The substrate of claim 21, wherein said substrate is a substrate making up the bottom surface of a multiwell plate.

24. A method of separating materials in a composition comprising
packing a cylindrical column with the stabilized colloidal crystal of claim 11 or a substrate that has been coated with the stabilized colloidal crystal,
passing a composition containing a mixture of chemical species through the column, and
recovering the fractions obtained thereby for further processing and/or analysis.

25. A method of capturing materials in a composition comprising
packing a cylindrical column with the stabilized colloidal crystal of claim 11 or a substrate that has been coated with the stabilized colloidal crystal,
passing a composition containing a mixture of chemical species through the column, and
recovering the captured fraction obtained thereby for further processing and/or analysis.
